(19) United States
(12) Patent Application Publication
(10) Pub. No.: US 2011/0055915 A1
(43) Pub. Date: Mar. 3, 2011

(54) METHODS OF PROVIDING DIGITAL CONTENT TAILORED TO USERS OF PRIVATE NETWORKS WITHIN A PROTECTED VIRTUAL ENVIRONMENT

(75) Inventors: Richard M. Hall, Henderson, NV (US); Keith Greene, Las Vegas, NV (US)

(73) Assignee: ONSITE CONCIERGE, Henderson, NV (US)

(21) Appl. No.: 12/873,255

(22) Filed: Aug. 31, 2010

Related U.S. Application Data
(60) Provisional application No. 61/275,346, filed on Aug. 31, 2009.

(51) Int. Cl. G06F 21/00

(52) U.S. Cl. 726/12

(57) ABSTRACT

A method of communicating valuable digital information to users is provided that utilizes, in some cases, a proxy server to white list significantly greater amounts of information available on the internet to penetrate protective virtual barriers such as firewalls or walled gardens, and in which such digital information is conveyed in a significantly tailored arrangement by assessing more precise geographic location data of the user during the process.

### RELATED U.S. APPLICATION DATA

This application is a non-provisional application based upon and claims priority to U.S. Provisional Application No. 61/275,346 filed on Aug. 31, 2009, the entire contents of which is incorporated herein by reference and by inclusion.

### FIELD OF THE INVENTION

The present invention relates to a process of communicating with a user within a private network relevant and meaningful digital information in an environment that mutually benefits the user, the transmitter of the information, the originator of the information, and the host of the private network.

### BACKGROUND

Digital information abounds today. Such information consists of educational information, social information, marketing information, business information, and various forms of entertainment, just to name a few. Much of the digital information presented constitutes revenue-generating advertising because there exists such huge captive audiences that advertisers can potentially reach electronically.

Getting all of that information to relevant recipients remains an issue, for numerous reasons. Often, virtual protective barriers are put into place either to insulate users from malicious or destructive information or to insure that certain users or providers are in compliance with applicable regulatory rules. Examples of such protective barriers are firewalls and walled gardens, terms of art that have become or are becoming well known even beyond those in the art.

A firewall is a part of a computer system or network that is designed to block unauthorized access while permitting authorized communications. It is a device or set of devices configured to permit or deny computer applications based upon a set of rules and other criteria. Firewalls are frequently used to prevent unauthorized internet users from accessing private networks connected to the internet, especially intranets. All messages entering or leaving the intranet pass through the firewall, which examines each message and blocks those that do not meet the specified security criteria.

A walled garden is an analogy used in various senses in information technology. In the telecommunications and media industries, a walled garden refers to the control that a service provider or carrier has over applications, content, and media on platforms and restrictions to convenient access to non-approved applications or content. More generally, a walled garden refers to a closed or exclusive set of information services provided for users. An example is a hotel's intranet that guests can enter with their computer (when connected) or through the guest room TV, also known as a private network. So that the reader may appreciate more clearly the invention and the context of the solution provided by the invention, certain terms of art are defined below. It is intended that the definitions reflect the normal usage in the art as understood by the inventors. For purposes of describing embodiments of the invention herein, the term firewall will be used to cover both a firewall and a walled garden.

A computer network system, often simply referred to as a network, is a collection of computers and devices connected by communication channels that facilitates communications among users and allows users to share resources with other users. Computer networks can be classified according to the hardware and software technology that is used to interconnect the individual devices in the network, such as optical fiber, ethernet, wireless, or LAN, etc. Ethernet uses physical wiring to connect devices. Frequently deployed devices include hubs, switches, bridges and/or routers. Wireless LAN technology is designed to connect devices without wiring. These devices use radio waves or infrared signals as a transmission medium.

An internet protocol address, or more readily called an IP Address, is a numerical label that is assigned to electronic devices (e.g., computers) participating in a computer network that use the internet protocol for communication between the devices within the network; e.g., between computers linked to the network. An IP address serves two principal functions: it serves to identify the host or network, and it serves to provide location addressing. Much like the postal address of a home designed to ensure that mail arrives at its proper destination, an IP address is designed to ensure that digital content is directed to the right user or host.

Distinguished from the internet, the intranet is a private computer network that uses internet protocol (IP) technologies to securely share any part of an organization's information or network operating system within that organization (or host). The term is used in contrast to internet, a network between organizations, and instead refers to a network within an organization. Sometimes the term refers only to the organization's internal website, but may be a more extensive part of the organization's information technology infrastructure. It may host multiple private websites and constitute an important component and focal point of internal communication and collaboration.

An intranet is built from the same concepts and technologies used for the internet, such as client-server computing and the internet protocol suite (TCP/IP). Any of the well-known internet protocols may be found in an intranet, such as HTTP (web services), SMTP (e-mail), and FTP (file transfer). Internet technologies are often deployed to provide modern interfaces to legacy information systems hosting corporate data. An intranet can be understood as a private analog of the internet, or as a private extension of the internet confined to an organization.

Importantly, intranets may provide a gateway to the internet by means of a network gateway with a firewall, shielding the intranet from unauthorized external access. The gateway often also implements user authentication, encryption of messages. Certain embodiments of the invention as described herein solve a problem caused by the existence of the protected gateway in communicating digital content to users that have convenient access to an intranet, but must execute certain procedures in order to reach the internet.

A private network is a network that uses private IP address space, following the standards set by RFC 1918 and RFC 4193. These addresses are commonly used for home, office, and enterprise local area networks (LANs), when globally routable addresses are not mandatory, or are not available for the intended network applications. These addresses are characterized as private because they are not globally delegated, meaning they are not allocated to any specific organization, and IP packets addressed by them cannot be transmitted onto the public internet. Anyone may use these addresses without approval from a regional internet registry (RIR). If such a private network needs to connect to the internet, it must use either a network address translator (NAT) gateway, or a proxy server.

The complex communications infrastructure of the internet consists of its hardware components and a system of software layers that control various aspects of the architecture. While the hardware can often be used to support other software systems, it is the design and the rigorous standardization process of the software architecture that characterizes the internet and provides the foundation for its scalability and success. The principal methods of networking that enable the internet are contained in specially designated internet standards. Internet Standards describe a framework known as the internet Protocol Suite. This is a model architecture that divides methods into a layered system of protocols (RFC 1122, RFC 1123). The layers correspond to the environment or scope in which their services operate. At the top is the Application Layer, the space for the application-specific networking methods used in software applications, e.g., a web browser program. Below this top layer, the Transport Layer connects applications on different hosts via the network (e.g., client-server model) with appropriate data exchange methods. Underlying these layers are core networking technologies, consisting of two layers. The internet Layer enables computers to identify and locate each other via internet Protocol (IP) addresses, and allows them to connect to one-another via intermediate (transit) networks. Lastly, at the bottom of the architecture, is a software layer, the Link Layer, that provides connectivity between hosts on the same local network link, such as a local area network (LAN) or a dial-up connection. The model, also known as TCP/IP, is designed to be independent of the underlying hardware which the model therefore does not concern itself with in any detail. Other models have been developed, such as the Open Systems Interconnection (OSI) model, but they are not compatible in the details of description, nor implementation, but many similarities exist and the TCP/IP protocols are usually included in the discussion of OSI networking.

A proxy server is a server (a computer system or an application program) that acts as an intermediary for requests from clients seeking resources from other servers. A client connects to the proxy server, requesting some service, such as a file, connection, web page, or other resource, available from a different server. The proxy server evaluates the request according to its filtering rules. A proxy server may optionally alter the client's request or the server's response, and sometimes it may serve the request without contacting the specified server. In this case, it ‘caches’ responses from the remote server, and returns subsequent requests for the same content directly.

One application of the invention embodiments described below is communicating relevant content to a user more conveniently and meaningfully. For example, advertising is one form of relevant content. Advertising is a form of communication intended to persuade an audience (viewers or listeners) to purchase or take action upon products, ideals or services. Advertising may be transmitted using any media meant to reach a mass amount of people. Mass media includes broadcast advertising, print advertising, newspaper advertising, and internet advertising. Commercial advertisers seek to generate increased consumption of their products. Non-commercial advertisers seek to have consumers spend money or become aware of items other than commercial products or services, such as political parties, interest groups, religious organizations and governmental agencies.

Virtually any medium can be used for advertising. Commercial advertising media can include wall paintings, billboards, street furniture components, printed flyers and rack cards, radio, cinema and television advertisements, web banners, mobile telephone screens, shopping carts, web pop-ups, skywriting, bus stop benches, human billboards, magazines, newspapers, town criers, sides of buses, banners attached to or sides of airplanes, in-flight advertisements on seatback tray tables or overhead storage bins, taxicab doors, roof mounts and passenger screens, musical stage shows, subway platforms and trains, shopping cart handles, the opening section of streaming audio and video, posters, and the backs of event tickets and supermarket receipts. Any place an “identified” sponsor pays to deliver their message through a medium is advertising.

Out-of-home (“OOH”) advertising is essentially any type of mass media that reaches the consumers while he or she is outside of the home; “on the go” in public places, in transit, waiting (such as a medical office), and/or specific commercial locations (such as in a retail venue). Digital out-of-home (“DOOH”) advertising is a mass media sub-category of OOH advertising, and is comprised mainly of digital billboards and digital signage. DOOH advertising networks are called many things—including emerging media platforms, digital signage networks, private networks digital billboards, new digital media, and place-based media. In general, DOOH advertising refers to electronic signs that can be changed remotely without the cost of physically changing a manufactured or printed sign. The DOOH advertising business is in its infancy. As of March 2009, the Global Association of Marketing at-Retail, an international non-profit association, released the very first DOOH Standards, to establish benchmarks for the performance and behavior of these networks.

Digital signs, such as LED, LCD, plasma and projected images, can be found in public and private environments, such as retail stores and corporate locations. Often, digital signs are grouped together into networks that are controlled on-location, or from a centralized location, via a system configured to playback and manage content. digital signage relies on a variety of hardware to deliver the content. The components of a typical digital signage installation include one or more display screens, one or more media players, and a content management server. Sometimes two or more of these components are present in a single device but typically there is a display screen, a media player, and a content management server that is connected to the media player over a private network. One content management server may support multiple media players and one media player may support multiple screens. Stand-alone digital signage devices combine all three functions in one device and no network connection is needed.

Predictive behavioral targeting uses a linking of surveys and measurement data to open up the entire spectrum for behavioral targeting. A predictive behavioral targeting system learns from user behavior combined with survey or other third party data in real time. Machine-learning algorithms are put to work in order to provide ad servers with precise profile information for the whole inventory. predictive behavioral targeting is made possible through a technological predictive analytics system that analyzes and enhances user data in real time. Blind gifs are used to count the number of page hits per cookie and content page code. Additionally, random users are invited at certain intervals to take part in on-site surveys, providing information on the user's demographics, interests and lifestyle. This polling data is then overlaid onto the measurement data, allowing for a profile comparison. The profile will then be delivered to portal operators and their ad servers, who can then send out advertisements to the previously defined target group.

Geo-targeting in geo marketing and internet marketing is the method of determining the geographic location of a website visitor and delivering different content to that visitor based on his or her location, such as country, region/state, city, metro code/zip code, organization, IP address, ISP or other criteria. Use of proxy servers and virtual private networks (VPNs) may give a false location.

A decision-matrix method is a quantitative technique used to rank the multi-dimensional options of an option set. It is frequently used in engineering for making design decisions but can also be used to rank investments options, vendor options, product options or any other set of multidimensional entities. A basic decision matrix consists of establishing a set of criteria upon which the potential options can be decomposed, scored, and summed to gain a total score, which can then be ranked. Importantly, the criteria are not weighted to allow a quick selection process. The advantage of this approach to decision making is that subjective opinions about one alternative versus another can be made more objective.

A graphical user interface (“GUI”), is a type of user interface that allows users to interact with programs in more ways than typing such as computers; hand-held devices such as MP3 players, portable media players or gaming devices; household appliances and office equipment with images rather than text commands. A GUI offers graphical icons, and visual indicators, as opposed to text-based interfaces, typed command labels or text navigation to fully represent the information and actions available to a user. The actions are usually performed through direct manipulation of the graphical elements.

Knowing the exact location of a user is important to geo-targeting for advertising purposes. Presently, the only way to ascertain the exact physical location of a consumer on the private network is to ask them for that information. The common practice is to use GOIP Library lists to track IP addresses to within a vicinity of the user, such as within a zip code or within a city. This library will not identify the exact physical address, and has a reported altogether failure rate of around 10%. This often results in lesser relevant information being provided to the user. For example, a retailer having a sale that day that is located in one end of a city is generally not going to be meaningful to a tourist residing in a hotel on the other end of a city. Having a more precise location of the user permits the transmission of more meaningful digital content.

In one scenario, a user (e.g., a hotel guest), accesses the hotel intranet via the user's computer or through a system set up on the guest room T.V. Initially, the user initiates a “session” by simply establishing the connection to the hotel intranet. That session defines a unique time and place to which the user may have limited access digital information. In other words, based upon the time and place of the user's session, it is desired to provide relevant information to the user that is reflective of the user's locale and demographics. Depending upon whether the user undertakes to authenticate his or her session, enabling the user to access the internet, the scope of the digital content accessible to the user may be limited. Authentication of the session may involve the user's simply agreeing to comply with whatever terms are set forth by the host of the network. The terms may vary from network host to network host, including in some cases requiring a commitment to pay money (e.g., a daily or weekly internet access rate), but the user can elect to execute the appropriate steps to authenticate the session and then explore the internet.

Where the user chooses not to execute the steps to authenticate the session, a great deal of information available on the world wide web does not reach the user. The firewall (including the walled garden) serves both to restrict access of the user to the internet and to restrict the web's wealth of information to the user. The problem is that valuable information is lost to the user. That lost information translates often to lost revenue to a retailer that would otherwise view the user as a potential customer. That is yet another problem to providing relevant digital content to users.

### SUMMARY OF THE INVENTION

In one embodiment of the invention, a method is used to provide authorized digital content to a user who is accessing a network protected by a firewall, where the network requires the user to obtain authentication before the user can penetrate the firewall. In this embodiment, the method comprises providing a proxy server that is capable of establishing a virtual tunnel between advertisers and the user through the firewall; collecting digital content that is (i) stored outside the firewall and (ii) is inaccessible to the user prior to authentication and (iii) has relevance to the user based upon information about the locale where the user is situated; and rewriting such digital content before transmitting it to the user so that said rewritten digital content may penetrate the firewall prior to the user's having obtained authentication, whereby, prior to authentication, the user may have access to such rewritten digital content in a way that has substantially the same look and feel of the digital information prior to being rewritten so as to permit the user experience to be similar to that which the user would have enjoyed after authentication.

In this or another embodiment, the proxy server may be used to rewrite the digital content and transmits it through the firewall to the user. The information about the locale may comprise geographical information and an IP address. The network being served by the invention may be associated with a tourist destination where the user presently resides.

In another embodiment, a method is used of tailoring the relevance of digital information for receipt by users within networks. In that regard, the method may comprise collecting geographical information on hosts of networks accessible to the users; collecting the IP address for portals within the networks where users may access the network; associating the geographical information with the IP addresses so that future determinations may be made about the geographical location of a user based upon the user's portal IP address; and selectively transmitting digital information to the user that is relevant to the user based upon the geographical location of the user, whereby the digital information transmitted has geographic relevance to the user without the need to ask the user for his or her geographic location. The transmission of the digital information may be provided by a proxy server that is pre-authorized by the network host to send such information to the network. In this or another embodiment, the digital information is rewritten from its original form as stored on a server not associated with either the proxy server or the network. The rewriting of the digital information permits such information to become accessible to the users within a firewall set up by the network host that the firewall would have otherwise blocked.

In another embodiment, a network system is provided comprising a marketing device in a public space with a plurality of inputs that are used for customer transactions and a centralized system for which the marketing devices are controlled. The network system may further comprise customer interaction with advertisements on marketing devices organized through a configuration matrix. The network system may further comprise the mapping and selection of public device locations, as individual locations or as groups of locations, to display marketing messages. The network system may further comprise users affecting outcome of advertisements displayed at individual locations where users initiate advertising in a public place. The network system may further comprise features that can send advertisement or promotions to email, printed, or mobile device at the specific option of the end user. The collection and use of data through the network system may be combined with existing and third-party data to affect the display of marketing messages. Third party data includes predictive behavior targeting.

The network system may be provided for the entry and management of individual or group marketing messages, by the owner of the public device and the advertisers, simultaneously or individually, from a central location, from the public device, through a personal computer, and/or handheld device connected to the internet. The network system may further comprise a system for revision of individual or group marketing messages, offers, and incentives, either per individual public device, or as a group of public devices, from a central location, from the public device, through a personal computer, and/or handheld device connected to the internet. The network system may further comprise redemption of offers made through the internet via traditional print and broadcast marketing media, via wireless devices, at a public device, which in return provides marketing messages, offers and incentives to the individual redeemer in the form of printed material sent to their email, through the internet, or to a wireless device. The public device may comprise a kiosk.

In another embodiment, a configuration matrix is provided comprising of a set of rules that are automatically initiated at a central computer system for the purpose of providing a tool for generating a marketing campaign. The configuration matrix may further comprise an option to have a manual overview of the marketing campaign for quality assurance. A system may be employed such as described above that can be layered onto existing computer systems in a manner that retains the functionality of existing computer systems that are in place, but allows the new addition of the marketing device generated by a configuration matrix. A set of marketing tools may be provided that allow re-configuration of advertisement campaigns based on recursive use of the configuration matrix that is driven by networked systems tracking the data output from the initial and subsequent revised advertisement campaigns.

In another embodiment, an advertisement production display generated for end users based on rules set forth for advertisers participation may be provided. Such a system may further comprise information gathered from physical business locations oriented that are referenced in the advertisements. The system may further comprise mobile phone displays, remote displays, or text information that can be sent to users guiding them to the direction of the nodes running the campaigns.

In yet another embodiment, a network system is provided comprising a computer with a plurality of input that are used for customer transactions, in which the computer supplies sets of input based on individual marketing schemes, sends output based on customer interaction at the computer, and supplies sets of input based on further processing the output of the customer transactions back through a network to the same computer for refined marketing scheme. The network system may utilize a recursive process that can be manually re-routed to the computer through the network, or automatically routed through the network. The network system may further utilize a feedback mechanism to the marketer so that the current marketing scheme can be refined by recursive methods.

In another embodiment, a system is provided for mapping and selecting public device locations, as individual locations or as groups of locations, to display marketing messages, where selection and prioritization of marketing messages displayed may be based on current and past data collected, and/or where multiple advertisement nodes with campaigns can be referenced by location and position.

### BRIEF DESCRIPTION OF THE FIGURES

FIG. 1 shows a flow chart illustrating one embodiment of the inventive methodology described herein, wherein a proxy server is used to communicate with users within a virtual protected environment.

FIG. 2 shows a more detailed flow chart reflecting a single user in communication with digital content originating from multiples sources through a proxy server.

### DETAILED DESCRIPTION

For purposes of the description herein, multi-dimensional analysis is a data analysis process that groups data into three or more categories for the purpose of weighting the importance of each piece of data and of each group of data, and then comparing those fields against an established norm. Singular pieces of data may be referred to as an option, and combined as an option set. For example, a data (or option) set may consist of the number of hotel rooms in a hotel as a single-dimensional (or longitudinal) data set. A data set consisting of the number of hotel rooms in several hotels within a single city may also be a single-dimensional data set. If a new factor is added into the mix, for example a second city, along with information on one or more hotels within that city, a two-dimensional data set results. Two or more data sets may be considered multi-dimensional, although often the term is used for three or more factors, such as the hotel brand, the city, and the number of hotel rooms. The three dimensions provide more information than can be gleaned from two-dimensional data sets. Due to the large amounts of data on the open internet, current search engines limit the number of options in their analysis. Adding more options exponentially increases the complexity, and therefore the computing power necessary, of providing an accurate response to the query. Adding persona information, or using a more precise physical address in the option set, are examples of what embodiments of the present invention inventive.

In one embodiment of the invention, a method utilizes a unique decision-method matrix, a quantitative technique that ranks the multi-dimensional options of an option set, and utilizes database search engine technology to automatically select digital content (e.g., specific local and national news and information along with paid offers and advertisements stored on digital network servers), displays the content via a network device, such as computer terminals, personal computers (PCs), mobile devices, and electronic kiosks, being used by consumers, connected to the public internet via private intranet networks.

Unique to this invention is the process by which the digital content is selected and served to the devices connected to the private/public network; i.e., utilizing the decision-matrix method and search engine technology to serve content to consumers utilizing a private/public network connection with certain option set criteria. The physical location of each private network server that provides the consumer access to the private/public network connection, regardless of whether the consumer receives this service free or is required to pay for access in such cases as inside hotels or cafes, has been manually assigned a location identifier (the “Location ID”). In one embodiment, the Location ID is assigned based on the following criteria:
a fairly precise geographic location of the specific private network server;
the unique IP address of the private network devices; and
the service provided by the specific private network server.
   As an example, within a hotel, the servers for the wired and wireless high-speed internet service (the “HSIA,”), the computers in the business centers, and the public lobby kiosks, each provide different services to consumers, and therefore would receive unique Location IDs. Whereas the prior art geographic information consisted of a city or a zip code, certain embodiments of the present invention zero in one a more precise location of the user, preferably within a few blocks of the location, and more preferably the physical post address of the user. In even more preferable embodiments, the location is reflected by the exact longitude and latitude coordinates. Any level of precision greater than just the city or zip code yields significantly more useful and relevant content to the user. The more relevant the content, the more likely it benefits all parties involved, including the user, who does not have to deal with noise in the form of worthless advertisements or other information. It benefits the originators of the content because they are able to target users who are more likely to be potential customers or patrons, the transmitters of the content who are providing a more valuable service to the content originators by targetting more relevant users, and the network hosts who are looking to improve service to their customers, and may benefit economically from any resulting transactions.

The Location ID is an important feature of some of the embodiments of the inventive methodologies because it permits more tailored content for the user; i.e., more relevant content. Geographic location, as used for purposes of describing embodiments of the present invention, therefore, refers to geographic data that locates the user at least within a few blocks of his or her actual location, if not more precisely to exact coordinates. The term, however, is intended to include exact coordinates.

Additionally, for a consumer to be granted a private/public network connection they are required to complete an authentication process, whereby the consumer (user) must agree to legally binding terms and conditions outlined on a secure entry page such as a log-in page. To move beyond the log-in page, there must be positive confirmation of the Location ID, along with consumer acceptance of the terms and conditions, both verified by a proxy server, resulting in a consumer session. So in one sense, the Location ID plus the consumer acceptance of the terms and conditions equals the consumer session.

The digital content to be displayed during a consumer session are automatically selected, utilizing the matrix, factoring two or more of the following criteria; the Location ID, information gathered during consumer sessions, and actual or contrived consumer personas—creating a dynamic predictive behavior target. In the study of communication, persona is a term given to describe the versions of self that all individuals possess. Behaviors are selected according to the desired impression an individual wishes to create when interacting with other people. Therefore, personae presented to other people vary according to the social environment the person is engaged in, in particular the persona presented before others will differ from the persona an individual will present when he/she happens to be alone. Predictive behavioral targeting uses a linking of surveys and measurement data to open up the entire spectrum for behavioral targeting. A predictive behavioral targeting system learns from user behavior combined with survey or other third party data in real time. Machine-learning algorithms are put to work in order to provide ad servers with precise profile information for the whole inventory. Predictive behavioral targeting is made possible through a technological predictive analytics system that analyzes and enhances user data in real time. Blind gifs are used to count the number of page hits per cookie and content page code. Additionally, random users are invited at certain intervals to take part in on-site surveys, providing information on the user's demographics, interests and lifestyle. This polling data is then overlaid onto the measurement data, allowing for a profile comparison. The profile will then be delivered to portal operators and their ad servers, who can then send out ads to the previously defined target group.

The user persona is determined in one embodiment, for example, by utilizing any combination of the following:
personal information, actual or contrived, entered by the consumer via questionnaire of online form;
pseudo personas selected by the consumer or by using the inventive methodologies described herein;
information gathered from outside profiling sources such as Nielsen, Arbitron and Claritas;
information gathered from current or past consumer Sessions of the individual consumer or groups of consumers;
information on the geographic location of the private network servers;
information on the demographic and lifestyle characteristics of consumers that historically visit the location of the Private Network servers. As an example, a Ritz Carlton Hotel historically attracts different consumers than a Best Western Hotel; likewise, McDonalds historically attracts different customers than Starbucks.

As the consumer chooses to enter a term, or “query” in the search box provided on the GUI, the search query further refines the content displayed on the network device.

Advertisements are either provided by the advertiser, or are created and stored on network servers utilizing an automated online ad builder program. Advertisers request the duration, number of locations, frequency, position, and therefore determine the budget of their ad campaigns utilizing the automated media plan builder program.

On embodiment prioritizes the advertisements within the GUI based on a set of computer parameters, including the price paid for each advertisement, and the volume of advertisements purchased by the advertiser. Not unlike prime real estate, the more someone is willing to pay, the better location. The media plan builder is a rules-based system that allows advertisers to improve the visibility of their advertisements at any time by “bidding” their way into better locations. Safeguards exist within the system so that multiple advertisers can't accidentally purchase the same areas on the GUI.

When network system devices (other than PCs) are idle, one inventive embodiment utilizes this “quiet time” to run a secondary system that operates much like a digital sign or digital out-of-home network, displaying Advertisements back-to-back on a “video loop” for the purpose of promoting the products and services of advertisers, as well as highlight the benefits of the system, attracting consumers the networks system devices.

To give an example of the implementation of one embodiment of the present invention, when a web browser loads a web site located on the internet, it typically requests a default or index page. That page will consist of a set of HTML markup commands that describes the basic structure of that page to the browser. Included in the markup commands are links to other external resources that the browser may require to render the web page properly. Other resources may include JavaScript files, cascading style sheet files, image files, Adobe® flash files and other files. A typical HTML markup file may look like this:

```
<html>
  <head>
    <title>My Web Page</title>
    <link rel=“stylesheet” type=“text/css”
href=“http://www.mywebsite.com/css/index.css” />
    <script type=“text/javascript”
src=“http://www.mywebsite.com/js/jquery.min.js”></Script>
  </head>
  <body>
    <h1>This is my webpage</h1>
    <img src=“http://www.mywebsite.com/images/header.jpg”
    alt=“My Web
Page Header Graphic”/>
    <br/>
    Welcome to my simple web page. Here is some flash:<br/>
    <object>
      <param name=“movie”
value=“http://www.mywebsite.com/my_flash_movie.swf”>
      <param name=“quality” value=“high”>
      <param name=“wmode” value=“transparent”>
      <embed src=“http://www.mywebsite.com/my_flash_movie.swf”
quality=“high” width=“400” height=“300” wmode=“transparent”/>
    </object>
    <br/>
    Thanks for viewing my website!<br/>
    <a href=“http://www.someotherwebsite.com”>Click here to visit
    some other
website!</a>
  </body>
</html>
```

In one embodiment of the present invention, a proxy server is provided and configured to rewrite many, but preferably each, external resource link so that those links are reached by the user through the proxy server itself. In the above example, the inventive methodology would comprise rewriting the code to what is disclosed, by example only, below, before returning it to the browser:

```
<html>
  <head>
    <title>My Web Page</title>
    <link rel=“stylesheet” type=“text/css”
href=“http://www.myproxyserver.com/www.mywebsite.com/css/
index.css” />
    <script type=“text/javascript”
src=“http://www.myproxyserver.com/www.mywebsite.com/js/
jquery.min.js”></script >
  </head>
  <body>
    <h1>This is my webpage</h1>
    <img
src=“http://www.myproxyserver.com/www.mywebsite.com/images/
header.jpg”
alt=“My Web Page Header Graphic”/>
    <br/>
    Welcome to my simple web page. Here is some flash:<br/>
    <object>
      <param name=“movie”
value=“http://www.myproxyserver.com/www.mywebsite.com/
my_flash_movie.swf”>
      <param name=“quality” value=“high”>
      <param name=“wmode” value=“transparent”>
      <embed
src=“http://www.myproxyserver.com/www.mywebsite.com/
my_flash_movie.swf
” quality=“high” width=“400” height=“300” wmode=“transparent”/>
    </object>
    <br/>
    Thanks for viewing my website!<br/>
    <a
href=“http://www.myproxyserver.com/
www.someotherwebsite.com”>Click here
to visit some other website!</a>
    </body>
</html>
```

With this arrangement, the browser can now start requesting other external resources through the proxy server, which will read the content of those files and rewrite any links to external resources within those pages, and so on down the line until the page is done loading. Using this method, any external website, content, or advertisement can be delivered through the firewall (i.e., into the walled garden) through the proxy server because the proxy server's URL (http://www.myproxyserver.com/ in the example above) has already been approved, or “white listed” by the host network used by the user.

Simply stated, once the proxy server is white listed, any of the web sites, content or advertisements that come through the fire wall (i.e., into the walled garden), onto the private/public network via the proxy server is also approved, and therefore displayed to the user. Without the benefit of the inventive methodologies, each web site and all links within that web site, as well as all content and advertisements, must be individually white listed in order to gain access to a network protected by either a walled garden or a firewall.

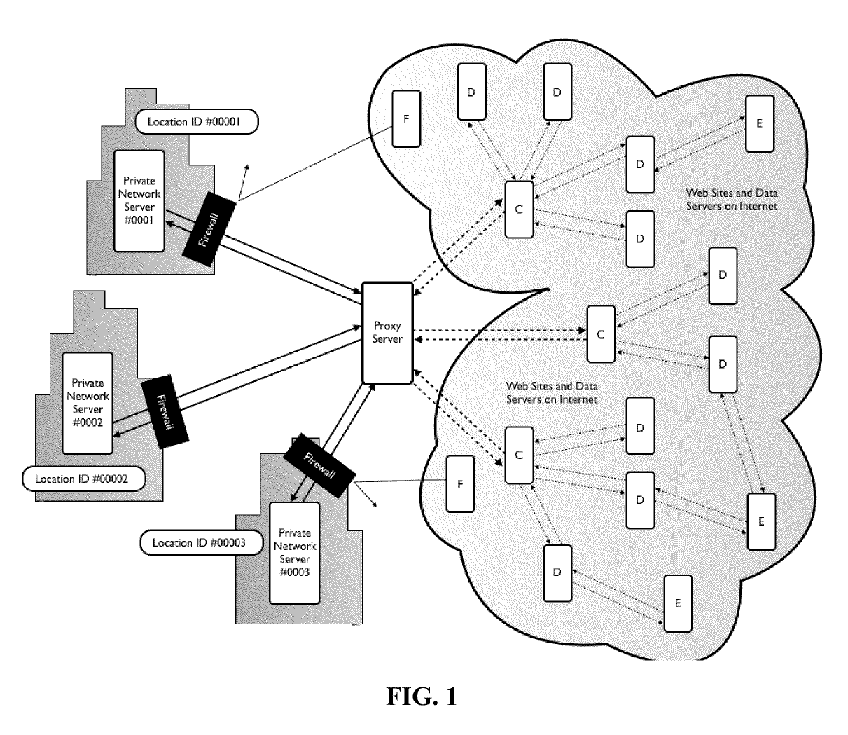

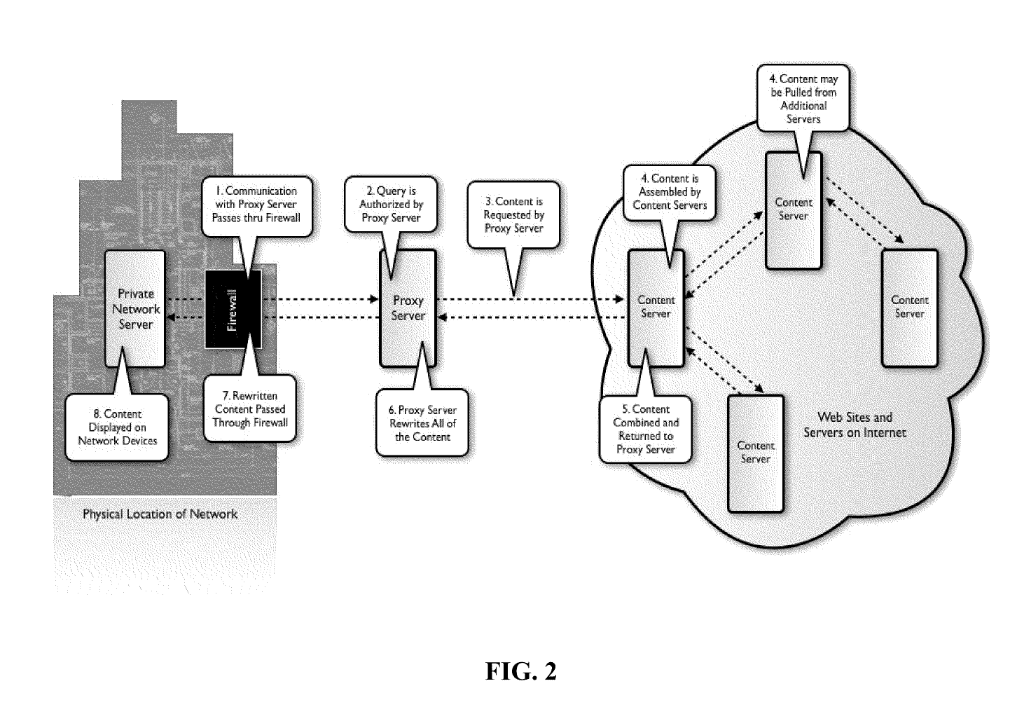

Referring to FIG. 1, it can be appreciated that a proxy server is provided that functions in part as a funnel to communicate digital content between a user on a private network and third party originators of digital content. By using the proxy server as an intermediary device, information on the internet that would otherwise not be conveniently available to a private network user may be accessed. Referring to FIG. 2, a bit more detail may be described. The flow chart of FIG. 2 reflects the directions of communications between a user within a private network having a firewall (including possibly a walled garden) and digital content originating on one or more servers, all passing through the proxy server. In one embodiment of the inventive methodology, the proxy server has been white listed prior to the user establishing connection to the private network so that communication between the user and proxy server through the firewall is possible. Any query submitted by the user is authorized by the proxy server, which then sends a request for response content for servers of third party providers of such content. The responsive content is gathered by the content servers, including possibly pulling additional information from other third party content servers, and assembled for return to the proxy server. The proxy server rewrites certain aspects of the content to accommodate the need for the information to be white listed. Then it is transmitted through the firewall for display on the user's monitor within the private network.

It should be noted that embodiments of the present invention may comprise a system that automatically generates offers and advertisements based on input that dynamically configures advertisements based on specific business advertising budgets and target audience. The information displayed to the end users is determined by businesses that selectively choose to participate in the advertisements at the location where the end users are located and that are running advertising campaigns. Advertisements and offers are presented to the customers through a network system to computer terminals, wireless devices, and kiosks, to name but a few examples.

In addition, an object of this invention is to take advantage of “quiet time” or unused time on computer terminals already deployed at locations for separate purposes. This could include public area kiosks, business center computers, or other computers placed in areas where there is public access. The application can be placed in conjunction with existing functional public use computers so that the utilization of these computers is extended.

Alternatively, the system can be configured so that the output of the decision matrix has an additional, secondary step involved at the site controlling the advertisements whereby content is filtered and final approval is made prior to any fully automatic configuration of the advertisements. This step ensures quality of the final deployment advertising screen as well as filtering for unwanted or inappropriate advertisements. For example, three separate regional advertisers along with a global advertiser decide they want to utilize this system for getting their advertisements and offers out to the end users. Each advertiser goes through a decision matrix process, this matrix is a set of rules and costs associated with preferences that the advertiser decides. Once the advertisers complete the matrix, there is a resulting set of advertising displays that will be produced at one or more end locations, such as a hotel kiosk. The resulting screen based on the multiple matrix input will contain a combination of advertisements or offers based on the matrix filters. Inclusive on the screen would be a host of advertisements from the regional and global advertisers. The size, shape, color, position and content will be based on pricing within the matrix input, resulting in a combined multiple advertisement screen that users will interact with.

The benefit to the advertiser is that they have a host of network end computers to select and prioritize their own advertisements based on what level of pallicipation is selected in the matrix. A regional advertiser, for instance, has the option of advertising in other areas, but can select only those end nodes that apply to their regional audience.

The matrix and associated rules with the system is based at a central computer location, so that the matrix rules can easily be updated and changed from time to time. Additional safeguards exist within the system so that multiple advertisers can't accidentally purchase the same marketing areas on the screen.

In conjunction with the advertisements generated through the matrix, the system has additional features whereby the actions of the end users are tracked. This information can then be utilized in a manner whereby a combination of the advertisement matrix can be adjusted for individual user behavior. For example, a set of advertisers may have priority of being on the top portion of the initial screen displayed to the customer, however, a subset of advertisers may further relate to fast food promotions. If a user that has previously interacted at the screen and selected fast food 90% of the time, then the system would organize the display to combine the subset of advertisers relating to fast food along with the matrix whereby advertisers have prioritized their individual campaigns; resulting in a dynamic advertisement displayed to the customer based not only on the advertisers, but on previously tracked user-interactions.

There are systems in place that advertise products on interactive displays, but these are typically for the venue or operator that owns the advertisement hardware. For those systems that may combine advertisements from multiple sources, the unique methods contained herein for producing final input screens to the user are disclosed that differentiate these methods as being unique. It is contemplated that the methods utilized in this art are unique for a variety of reasons, as described below.

At least some embodiments of the present invention solve certain problems associated with advertisers that are trying to reach the public, and get reasonable feedback on the marketing campaign dollars spent on the advertisement. Advertisers can use alternative methods defined in the invention that allow the advertiser to get immediate feedback from a campaign they themselves develop through the system. This relates to the ability for the advertiser to capture audiences in locations such as hotel business centers where computers are currently deployed. The application system allows the advertiser to customize offers that will be presented by the system described herein on terminals or user interactive devices throughout the demographic area in which the advertiser wants exposure. Additionally, the offers contain coupons or promotions directly to the customer for use at the advertisers regional area in proximity to the actual device locations. A consumer, then, has the ability to get value added offers at locations that they would not normally expect these to reside. In these configurations, the concierge or person suggesting attractive offers known to him or her in the area, could be replaced or augmented by the offers and advertisements located on computers within proximity of the customers. Prior to the deployment of this product, the advertisers only way of getting information to the consumer at these locations would be through direct marketing, sign age, or similar dedicated advertisements.

Another augmented feature unique to this invention is the benefit to the customer being able to interact with the advertisement at the terminal and have the promotional offer sent to them via e-mail, text, or printed form without any actual representative interacting with the customer which often is an issue during late hours when a concierge is not present at the location.

Yet another problem the system solves is the actual measurement of the interactions with the promotional offers setup at the location by the advertiser through this system. Other advertising methods do not allow the advertiser to measure the affect of the expense of their campaign cost via campaign feedback. This system will track any interaction with offers, and also validate when the offer is accepted, thus giving the advertiser sufficient information to continue, redesign, or stop their marketing campaign through the actual customer use measurement.

In one embodiment, the advertiser may take action by executing a decision matrix that allows the advertiser to configure their campaign. This pre-production process allows the advertiser to view their campaign prior to production of the final configuration. Once the advertiser is satisfied with their pre-production process through the configuration and decision matrix, the final advertisement will then automatically be part of the integrated production process, whereby multiple advertisers are combined into the production process. Optionally, the configuration and decision matrix may be sent to the a manual configuration where it can be reviewed for quality prior to integration into the production process. The combined layered process may have multiple nodes and may be accessed by end users. This process may contain zero or more standard processes and may contain a media process. The combined process allows for existing standard processes to exist that may be layered on top of the media process so that existing nodes with only standard processes can be updated in a manner to allow the addition of the advertising process.

The combined process typically resides on a computer device with display and input mechanism, such as a kiosk, workstation, or mobile device. Input from the process are filtered through the production process, whereby requests for advertisement promotions are sent to a central server for storing of information and reporting of information. Information stored in a data area of the central server may then be available for reporting of the results from the actions performed at the process as well as the target locations that may be sent to the advertiser.

Stored data will be available for reporting, billing, and analysis at the central location. The combined input sources provide a process that controls the advertisements resulting in activity at the target locations. Activity at the target locations that are typically locations owned or managed by the advertisers can be sent back to the media central site and stored for validation and optionally forwarded on to the advertiser for performance analysis. Results given to the advertiser from the stored data may be analyzed and, if necessary, the configuration and marketing campaign may be revised in order to produce yet another version of the final production processes in efforts to further improve upon the results of the stored data pertinent to the particular advertiser, this process is defined herein as the recursive marketing configuration matrix.

It may be appreciated that variations of the above embodiments and methodologies may be employed without departing from the spirit of the invention as claimed herein. The above embodiments are intended to illustrate examples of solutions to problems that exist in the communication of valuable digital information to users. Providing digital information that is relevant by tailoring the information transmitted to those users most likely to desire such information, and having such information dynamically updated to reflect temporal changes, is a significant advantage over what has come before. Providing a vehicle, such as a proxy server, to communicate with users in a way that white lists more information more quickly and conveniently also adds a great advantage in the two-way communication between third parties who have information to share and users who wish to obtain such information.

What is claimed is:

1. A method of providing authorized digital content to a user who is accessing a network protected by a firewall, where the network requires the user to obtain authentication before the user can penetrate the firewall, the method comprising:
providing a proxy server that is capable of establishing a virtual tunnel between advertisers and the user through the firewall;
collecting digital content that is (i) stored outside the firewall and (ii) is inaccessible to the user prior to authentication and (iii) has relevance to the user based upon geographical information where the user is situated;
and rewriting such digital content before transmitting it to the user so that said rewritten digital content may penetrate the firewall prior to the user's having obtained authentication,
whereby, prior to authentication, the user may have access to such rewritten digital content in a way that has substantially the same look and feel of the digital information prior to being rewritten so as to permit the user experience to be similar to that which the user would have enjoyed after authentication.

2. The method of claim 1, wherein the geographical information is associated with an IP address.

3. The method of claim 1, wherein the network is associated with a tourist destination where the user presently resides.

4. The method of claim 1, wherein the proxy server rewrites such digital content and transmits it through the firewall to the user.

5. A method of tailoring the relevance of digital information for receipt by users within networks, the method comprising:
collecting geographical information on hosts of networks accessible to the users,
collecting the IP address for portals within the networks where users may access the network;
associating the geographical information with the IP addresses so that future determinations may be made about the geographical location of a user based upon the user's portal IP address; and
selectively transmitting digital information to the user that is relevant to the user based upon the geographical location of the user,
whereby the digital information transmitted has geographic relevance to the user without the need to ask the user for his or her geographic location.

6. The method of claim 5, whereby the transmission of the digital information is provided by a proxy server that is pre-authorized by the network host to send such information to the network.

7. The method of claim 6, whereby the digital information is rewritten from its original form as stored on a server not associated with either the proxy server or the network.

8. The method of claim 7, whereby the rewriting of the digital information permits such information to become accessible to the users within a firewall set up by the network host that the firewall would have otherwise blocked.
